(19) United States
(12) Patent Application Publication
(10) Pub. No.: US 2012/0154895 A1
(43) Pub. Date: Jun. 21, 2012

(54) OPTICAL SYSTEM FOR GENERATING A LIGHT BEAM FOR TREATING A SUBSTRATE

(75) Inventors: Holger Muenz, Aalen (DE); Wolfgang Merkel, Neu-Ulm (DE); Damian Fiolka, Oberkochen (DE); Johannes Wangler, Koenigsbronn (DE)

(73) Assignee: CARL ZEISS LASER OPTICS GMBH, Oberkochen (DE)

(21) Appl. No.: 13/352,703

(22) Filed: Jan. 18, 2012

Related U.S. Application Data
(63) Continuation of application No. PCT/EP2010/060417, filed on Jul. 19, 2010.

(30) Foreign Application Priority Data
Jul. 31, 2009 (DE) 10 2009 037 141.9

(51) Int. Cl. G02F 1/11

(52) U.S. Cl. 359/285

(57) ABSTRACT

An optical system for generating a light beam for treating a substrate in a substrate plane is disclosed. The light beam has a beam length in a first dimension perpendicular to the propagation direction of the light beam and a beam width in a second dimension perpendicular to the first dimension and also perpendicular to the light propagation direction.

The optical system includes a mixing optical arrangement which divides the light beam in at least one of the first and second dimensions into a plurality of light paths incident in the substrate plane in a manner superimposed on one another. At least one coherence-influencing optical arrangement is present in the beam path of the light beam and acts on the light beam to at least reduce the degree of coherence of light for at least one light path distance of one light path from at least one other light path.

### CROSS-REFERENCE TO RELATED APPLICATIONS

This application is a continuation of, and claims benefit under 35 USC 120 to, international application PCT/EP2010/060417, filed Jul. 19, 2010, which claims benefit under 35 USC 119 of German Application No. 10 2009 037 141.9, filed Jul. 31, 2009. International application PCT/EP2010/060417 is hereby incorporated by reference in its entirety.

### FIELD

The disclosure relates to an optical system for generating a light beam for treating a substrate arranged in a substrate plane. The light beam has a beam length in a first dimension perpendicular to the propagation direction of the light beam and a beam width in a second dimension perpendicular to the first dimension and to the light propagation direction. The optical system includes at least one mixing optical arrangement which divides the light beam in at least one of the first and second dimensions into a plurality of light paths which are incident in the substrate plane in a manner superimposed on one another.

### BACKGROUND

An optical system for generating a light beam for treating a substrate arranged in a substrate plane is known from WO 2007/141185 A2. Such an optical system is used for example for melting materials, in particular in the field of the light-induced crystallization of silicon. One specific application is flat screen production, in which substrates provided with an amorphous silicon layer are treated using a light beam in order to crystallize the silicon. In this case, the substrates used have relatively large dimensions, for example in the range of greater than 30 cm×greater than 50 cm. With an optical system of this type, a light beam is generated which has a beam length in a first dimension (which is designated by X hereinafter), the beam length corresponding approximately to the width of the substrate (for example approximately 30 cm). In the dimension (designated by Y hereinafter) which is perpendicular to the X-dimension and which additionally runs perpendicular to the propagation direction of the light beam (which is designated by Z hereinafter), the light beam is thin.

The light beam thus applied to the substrate has a large ratio of beam length in the X-dimension and beam width in the Y-dimension, which can be greater than 5,000, even greater than 10,000, depending on the beam length.

It is desirable for the light beam used for treating the substrate to have a highly homogeneous intensity distribution at least in the (long) X-dimension, but also in the (short) Y-dimension.

The optical system known from WO 2007/141185 A2 has a mixing optical arrangement having two lens arrays, wherein each lens array has a plurality of lenses, for example cylindrical lenses, arranged beside one another in the X-dimension, and a condenser optical unit. Generally, a mixing optical arrangement serves to homogenize the light of the light beam in the substrate plane by mixing, i.e. by dividing the light beam into partial rays and superimposing them.

To simplify comprehension, the case is considered below where the mixing optical arrangement only brings about a homogenization of the light beam in the (long) X-dimension.

FIG. 1 illustrates the known optical system in a manner simplified further and provided with the general reference sign 1.

The optical system 1 has an optical mixing arrangement 2, which here, in order to simplify the illustration, has a lens array comprising only three individual lenses 2a, 2b, 2c and a condenser optical unit 3, the focal length of which is designated by f_{c}. The reference sign 4 represents a substrate plane into which the condenser optical unit 3 focuses.

An incident light beam 5 propagating in the propagation direction Z is divided by the mixing optical arrangement 2 into a plurality of partial rays, wherein, in the simplified example in which the mixing optical arrangement 2 has three individual lenses 2a, 2b, 2c, here the light beam 5 is divided into three partial rays that correspondingly propagate along three light paths 6a, 6b, 6c. The distance between respectively adjacent light paths 6a, 6b, 6c is designated by L in FIG. 1. The individual partial rays or the light paths 6a, 6b, 6c are superimposed on one another in the substrate plane 4 by the condenser optical unit 3. The light therefore passes to a field point in the substrate plane 4 on three light paths 6a, 6b, 6c.

On account of the dividing of the light beam 5 into a plurality of light paths 6a, 6b, 6c and the superimposition thereof in the substrate plane 4, intensity contrasts which arise as a result of interferences between the light from the different light paths 6a, 6b, 6c can arise in the substrate plane 4. In FIG. 1, in the right-hand partial figure, the intensity I is plotted against the coordinate x in the substrate plane 4. On account of interference phenomena, the intensity I is accordingly not homogenous.

Upon interference of two partial rays respectively inclined relative to one another, a periodic interference pattern in each case arises, which then superimpose. For the case shown here of a lens array having identical distances L between adjacent lenses, the interference periods that occur are multiples of one another. Between the interference period pₙ of the interference of light from two light paths having the distance n·L, the wavelength λ and the focal length f_{c} of the condenser optical unit 3 there is the following relationship:

$${p}_{n} = \frac{λ}{nL} {f}_{c} \qquad ( 1 )$$

In general, different interference periods pₙ associated with different multiples n L of the light path distance L occur in a superimposed fashion in the substrate plane 4.

It should be noted that the present disclosure is not restricted to optical systems whose at least one mixing optical arrangement generates light paths having a constant light path distance L from light path to light path, but also encompasses those in which the light path distance L can vary from light path to light path. In the latter case, the interference pattern then has a multiplicity of different interference periods which are superimposed to form an irregular pattern.

In order to reduce interference contrasts in the substrate plane 4, WO 2007/141185 A2 proposes dividing the light beam into a plurality of partial rays before it is incident on the mixing optical arrangement, and causing the individual partial rays to be incident on the mixing optical arrangement at different angles of incidence. The different angles of incidence of the individual partial rays on the mixing optical arrangement give rise to interference patterns which are offset relative to one another in the substrate plane given a suitable choice of the angles of incidence and which in total lead to an intensity I that is constant in the X-dimension if the individual partial rays are incoherent with respect to one another.

The dividing of the incident light beam into a plurality of non-parallel partial rays is achieved by mirrors in the known optical system, the mirrors being arranged in a pulse lengthening module.

In this optical system, it can be difficult to set the angular offset between the individual partial rays accurately enough that the interference patterns generated by the individual partial rays are offset relative to one another by an odd-numbered multiple of half the interference period in order that the interference contrast in the substrate plane is reduced or eliminated. Moreover, a pulse lengthening module of the known type generally generates a multiplicity of ever weaker partial rays having ever higher angles of incidence, which can likewise present difficulties.

### SUMMARY

The disclosure provides an optical system for generating a light beam for treating a substrate arranged in a substrate plane in which interference contrasts in the substrate plane are at least reduced in a simple manner.

According to the disclosure, at least one coherence-influencing optical arrangement is present in the beam path of the light beam and acts on the light beam to at least reduce the degree of coherence of the light for at least one light path distance of one light path from at least one other light path.

The disclosure involves the concept of reducing the lateral degree of coherence of the light incident in the optical system, which has at least one mixing optical arrangement which divides the incident light beam into a plurality of light paths in a direction transverse to the propagation direction of the light ray, at least for one light path distance, preferably minimizing the lateral degree of coherence to the value zero. In other words, the disclosure aims to reduce the lateral coherence to an extent such that light from different light paths is less capable of interference or no longer capable of interference at all.

The disclosure describes preferred measures by which, in a simple manner and without increased outlay on adjustment, it is possible to at least reduce the degree of coherence of the light for at least one light path distance of one light path from at least one other light path.

One measure includes reducing a ratio of the lateral coherence length of the light beam in a direction transversely with respect to the light paths and the light path distance between at least two adjacent light paths, preferably setting it to be less than two, and more preferably less than one.

If the lateral coherence length of the light beam in a direction transverse to the light paths is less than the light path distance between two adjacent light paths, then partial rays from these two light paths almost cannot interfere with one another. In other words, interference phenomena in the substrate plane can be almost completely avoided in this case. Given a predetermined natural lateral coherence length of the light used, for example light from an excimer laser, this can involve increasing the light path distance, i.e. fashioning the at least one mixing optical arrangement with fewer mixing optical elements for a predetermined extent of the light beam transversely with respect to the propagation direction, which, however, would reduce the homogenizing effect of the mixing optical arrangement.

A further preferred measure provides for the at least one coherence-influencing optical arrangement to have a beam splitter arrangement which splits the light beam in a direction transversely with respect to the light paths into a plurality of laterally offset partial rays whose propagation path differences relative to one another are greater than the temporal coherence length of the light of the partial rays.

In the case of this measure, the plurality of partial rays offset laterally relative to one another that are generated by the beam splitter arrangement are decoupled from one another by propagation path differences that are greater than the temporal coherence length of the light. With a lateral coherence length remaining the same, this arrangement quadruples the beam width, and the ratio of the lateral coherence length to the light path distances can thereby be correspondingly reduced. Semitransparent mirrors, prisms (using total internal reflection), offset plates or the like can be used as beam splitter arrangements. In contrast to the known optical systems, the partial rays can be parallel to one another.

A further preferred measure provides for the at least one coherence-influencing optical arrangement to have a coherence converter arrangement, which has a beam splitter arrangement, which splits the light beam in one of the two dimensions into a plurality of partial rays, and a beam resorting arrangement, which arranges the partial rays in the direction of the other dimension alongside one another.

Such a coherence converter arrangement which can be used in the present disclosure is described in the document DE 10 2006 018 504 A1. Such a coherence converter arrangement brings about, in the X-dimension of the light beam, an increase in the divergence and a corresponding reduction of the degree of coherence and of the lateral coherence length of the light in relation to the beam width.

In a further preferred configuration, the at least one coherence-influencing optical arrangement has at least one optical element whose light entrance surface and light exit surface are plane and inclined at an angle with respect to one another, wherein the at least one optical element is birefringent.

The use of birefringent wedges is known from U.S. Pat. No. 5,253,110 for the illumination system of a projection exposure apparatus for microlithography. In the present disclosure, however, such birefringent optical elements, for example wedges, are preferably used in combination with the abovementioned measure that the ratio of the lateral coherence length and the light path distance between two adjacent light paths is set in such a way that this ratio is at least less than 2. This is because the birefringent optical elements can be used to suppress an interference order (and the odd-numbered multiples thereof), in particular the first interference order, in a targeted manner, as a result of which the ratio of lateral coherence length and light path distance can be chosen to be twice as large as without such birefringent optical elements, which conversely means that, for the same interference ratios, the number of light paths of the at least one mixing optical arrangement can be chosen to be twice as large, which improves the homogenizing effect of the at least one mixing optical arrangement.

The interference-suppressing effect of the at least one birefringent optical element can be improved by the angle between the light entrance surface and the light exit surface of the optical element being chosen such that the phase difference—introduced by the optical element—between the ordinary and extraordinary partial rays for the at least one light path distance is an odd-numbered multiple of half the light wavelength.

As a result, the interference patterns generated by the ordinary and extraordinary partial rays are offset relative to one another by half a wavelength, such that the sum of the two interference patterns produces an intensity profile that is constant in the corresponding dimension of the light beam.

Particular preference is given to a combination of the abovementioned at least one beam splitter arrangement, the at least one birefringent element and the abovementioned measure of setting the ratio of lateral coherence length and light path distance to be less than 2, preferably less than 1. Likewise, the abovementioned at least one coherence converter can additionally be combined with these measures.

The combination of these measures leads to an even more effective reduction of the degree of coherence or minimization of the coherence function for avoiding interference contrasts in the substrate plane.

The at least one birefringent optical element is preferably arranged in the propagation direction of the light beam downstream of the at least one mixing optical arrangement.

A further preferred measure provides for a plurality of mixing optical arrangements disposed in series to be present instead of one mixing arrangement.

In this case, it is advantageous that the spatial period of the interference pattern in the substrate plane is reduced and the use of a birefringent element is facilitated.

A further measure for reducing the degree of coherence provides for the at least one coherence-influencing optical arrangement to have at least one acousto-optical modulator (AOM).

An acousto-optical modulator (AOM) has an optical element in which sound waves are generated for example by a piezoelement arranged at one end of the optical element. In this case, the propagation direction of the sound wave runs perpendicular to the incident light beam. In the AOM, the sound wave produces a spatial modulation of the refractive index which varies with the velocity of the sound wave. The light passing through the

AOM thereby experiences a phase shift δ which is dependent on position and time and which has, specified in fractions of the wavelength, the following form:

δ(x,t)=a sin[2π(x/Λ−fₛt)]

In this case, a is dependent on the sound amplitude and the extent of the sound field in the direction of the optical axis. Λ is the wavelength of the sound wave, and fₛ is the frequency of the sound wave. With sound velocity defined by the material of the AOM, it is possible to vary the wavelength Λ by the excitation frequency fₛ of the sound wave by the exciting element, e.g. piezoelement.

The time-dependent phase shift results in a decorrelation of the light from different locations, as a result of which the lateral coherence is reduced. The reduction of the degree of coherence and thus the reduction of the interference contrast for a light path distance L is dependent on the amplitude a and the wavelength 7 of the AOM and on the light path distance L.

In a further configuration of the measure mentioned above, the acoustic wavelength Λ and the acoustic amplitude a of the AOM are set such that the condition J₀[|2a sin(πL/Λ)|]<<1 is met for the at least one light path distance, where J₀ is the 0-th order Bessel function.

With the exception of the case where the acoustic wavelength Λ is equal to the light path distance L, the condition mentioned above can always be met by suitable sound amplitudes a. On account of the periodicity of the argument of the Bessel function, the condition also holds true for values L+mΛ, and owing to the symmetry it also holds true for the values (Λ−L)+mΛ, where m is an integer.

Thus, one AOM already significantly reduces the lateral coherence for a multiplicity of light path distances. For intervening light path distances, too, the AOM is not ineffective, even if the same extent of reduction is not achieved.

It is particularly preferred if a plurality of AOMs are present, in which the acoustic wavelength and/or the acoustic amplitude are/is set differently from AOM to AOM in order to at least reduce the degree of coherence for a plurality of light path distances.

Alternatively, for the purpose of reducing the number of optical assemblies to be provided, it can be provided that only one AOM is present, in which a plurality of different acoustic wavelengths with possibly different acoustic amplitudes are simultaneously generated in order to at least reduce the degree of coherence for a plurality of light path distances.

In a further preferred configuration, in the case where the light beam is pulsed, it is provided that, in addition to the at least one AOM, at least one pulse lengthening module is arranged in the beam path.

As already explained above, on account of the dynamic phase differences the AOM brings about a decorrelation of the light at different locations. This decorrelation is complete only when averaging can be effected over as many sound periods as possible having a uniform intensity, as is the case in particular for a laser in continuous-wave operation. For a short-pulse laser, by contrast, such as an excimer laser, in which the pulse duration of, for example, 20 ns is in the range of typical AOM frequencies of, for example, 20-100 MHz (period duration 10-50 ns), this condition is not met and residual interference contrasts occur in the substrate plane. The abovementioned measure of arranging at least one pulse lengthening module in the beam path of the light ray, in combination with the AOM, then avoids this disadvantage mentioned above. The pulse lengthening module lengthens the individual light pulses of the light ray. This is done for example by the light beam incident in the pulse lengthening module being split into two partial rays, and by one of the two partial rays passing through the delay line of the pulse lengthening module and being added to the other partial ray, which has not passed through the delay line. This gives rise to a longer pulse, the envelope of which is still modulated with the pulse duration of the input pulse.

It goes without saying that a plurality of pulse lengthening modules can be provided in order to lengthen the light pulses even further, if this is useful for reducing interference contrasts in the substrate plane.

In this case, it is furthermore preferred if the acoustic sound frequency of the AOM is coordinated with the lengthened pulses in such a way that an interference contrast in the image plane is less than 10%, preferably less than 5%, with further preference less than 1%.

This advantageously takes account of the fact that in the case of a pulse lengthening, too, there are acoustic frequency ranges of the AOM which cause an increased interference contrast in the substrate plane. These acoustic frequency ranges correspond to the circulation duration of the pulses in the pulse lengthening module that generates periodic intensity modulations which, if possible, are intended not to coincide with the sound frequency.

In a further preferred configuration of the measure mentioned above, the sound frequency fₛ of the AOM is not equal to the circulation frequency of the pulses in the at least one pulse lengthening module and not equal to the integral multiples of the circulation frequency.

“Not equal” means here that the sound frequency of the AOM is sufficiently different from the circulation frequency in the one or the plurality of pulse lengthening modules (and correspondingly also sufficiently different from the integral multiples of the circulation frequency or circulation frequencies) such that residual contrasts in the substrate plane that arise as a result of a coincidence of the sound frequency with the circulation frequency are avoided as far as possible. Preferably, the sound frequency of the AOM differs from the circulation frequencies and the integral multiples thereof by more than 10% in each case.

What is achieved with the above measure of coordinating the acoustic sound frequency is that upon the combination of the AOM with the pulse lengthening module in the substrate plane, interference contrasts are reduced as far as possible.

Here, too, it again goes without saying that the measure of the presence of at least one AOM and/or a pulse lengthening module can be combined with the abovementioned measures (setting the ratio of lateral coherence length and light path distance, birefringent optical elements, coherence converter, etc.) in order that interference phenomena in the light beam in the substrate plane are reduced as far as possible or completely eliminated.

Further advantages and features will become apparent from the following description and the accompanying drawing.

It goes without saying that the abovementioned features and those yet to be explained below can be used not only in the respectively specified combination, but also in other combinations or by themselves, without departing from the scope of the present disclosure.

### BRIEF DESCRIPTION OF THE DRAWINGS

Exemplary embodiments of the disclosure are illustrated in the drawings and are described in greater detail hereinafter with reference thereto. In the figures:

FIG. 1 shows an optical system in accordance with the prior art for elucidating interference effects that occur in the optical system;

FIG. 2 shows a basic schematic diagram of an optical system according to the disclosure;

FIGS. 3a) and 3b) show two bar charts showing the proportion of different interference orders in the case of a large coherence length (FIG. 3a)) and a small coherence length (FIG. 3b));

FIG. 4 shows an exemplary embodiment of a measure for suppressing interference effects in the optical system in FIG. 2 by providing a birefringent element;

FIGS. 5a) to c) show three bar charts showing the influence of the ratio of lateral coherence length and light path distance of a mixing optical arrangement with and without a birefringent optical element in FIG. 4;

FIG. 6 shows a modification of the exemplary embodiment in FIG. 4;

FIG. 7 shows a further exemplary embodiment of a measure for reducing interference effects of the optical system in FIG. 2;

FIG. 8 shows yet another exemplary embodiment similar to FIG. 7 of a measure for reducing interference effects of the optical system in FIG. 2;

FIG. 9 shows a further exemplary embodiment of a measure for reducing interference effects of the optical system in FIG. 2;

FIG. 10 shows a diagram showing three light pulse shapes;

FIG. 11 shows a diagram illustrating the dependence of interference effects as a function of the acoustic frequency of an acousto-optical modulator in accordance with FIG. 9 for the pulse shapes in FIG. 10;

FIG. 12 shows an enlarged excerpt from the diagram in FIG. 11;

FIG. 13 shows an example of a coherence function of the optical system in FIG. 2 if no measures for reducing interference are provided;

FIGS. 14 to 21 show different coherence functions, wherein the coherence function in accordance with FIG. 13 is illustrated by interrupted lines and the coherence functions such as are influenced by different measures for reducing interference by comparison with the coherence function in accordance with FIG. 13 are illustrated by solid lines.

### DETAILED DESCRIPTION

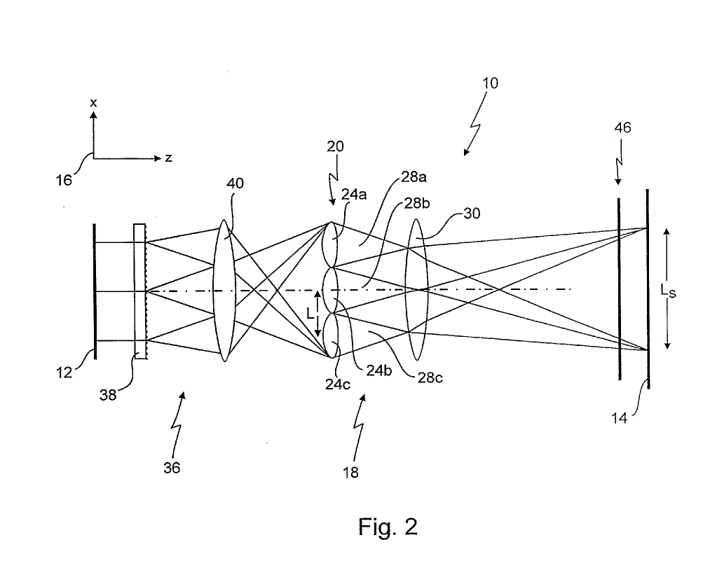

FIG. 2 schematically illustrates an optical system for generating a light beam for treating a substrate, the optical system being provided with the general reference sign 10.

The system 10 is used, in particular, in an apparatus for areally melting layers on substrates via a light ray. More specifically, the optical system 10 is used in an apparatus for crystallizing silicon layers made from amorphous silicon for flat screen production.

In such an apparatus for areally melting layers on substrates, the optical system 10 is a constituent part of an overall optical system comprising, alongside the optical system 10, even further optical units (not illustrated), for example a light source, in particular a laser, beam expanding optical units and the like. In such an overall optical system, the optical system 10 in accordance with FIG. 2 can be, as viewed in the light propagation direction, the last optically active unit upstream of the substrate, as illustrated here. The system 10 is correspondingly shown, as viewed in the light expansion direction, from an imaginary light entrance plane 12 of the light entrance into the optical system 10 as far as a substrate plane 14, in which a substrate (not illustrated) is situated.

The optical system 10 is designed to generate a light beam in the substrate plane 14, the light beam having a beam length Lₛ in a first dimension, which is designated as the X-dimension hereinafter, and a beam width in a second dimension, which is designated as the Y-dimension hereinafter, wherein the Y-dimension is perpendicular to the plane of the drawing from FIG. 2. In this case, the beam length L_{S} is very much greater than the beam width. The beam length L_{S} is more than 100 mm, for example approximately 300 mm, and the beam width is less than 50 μm.

In FIG. 2, the light propagation direction, which runs both perpendicular to the X-dimension and perpendicular to the Y-dimension, is designated by Z. In FIG. 2, which shows the optical system 10 in the XZ plane, a coordinate system 16 is furthermore depicted for illustration purposes.

The optical system 10 has a first mixing optical arrangement 18. The mixing optical arrangement 18 has an optical element 20. The optical element 20 divides the incident light beam in the X-dimension into a plurality of light channels or light paths 24a-c arranged beside one another, wherein only three such light paths 24a-c are shown in the exemplary embodiment shown, in order to simplify the illustration.

The optical element 20 is embodied in the form of a cylindrical lens array, wherein the respective cylinder axes of the individual cylindrical lenses extend in the Y-dimension, that is to say perpendicular to the plane of the drawing in FIG. 2. Instead of an individual cylindrical lens array, it is also possible to use a fly's eye condenser constructed from two cylindrical lens arrays.

In FIG. 2, the individual lenses are illustrated as biconvex cylindrical lenses, although it goes without saying that the lenses can also have other shapes, such as planoconvex, for example.

The light paths 24a-c of the optical element 20 divide the light beam incident in the optical element 20 in the X-dimension into a plurality of partial fields, wherein three partial fields 28a, 28b and 28c are illustrated by way of example in FIG. 2.

The first optical arrangement 18 also has, besides the cylindrical lens array, an additional condenser optical unit 30.

The optical system 10 has a further mixing optical arrangement 36, which is disposed upstream of the mixing optical arrangement 18 and which has a diffractive or scattering optical element 38 and a condenser optical unit 40, wherein the optical arrangement 36 directs the incident light beam, with the latter having already been premixed, onto the mixing optical arrangement 18.

Furthermore, the optical system 10 has an optical arrangement 46, which acts on the light beam only in the Y-dimension, in order to focus the light beam with a small beam width in the substrate plane 14.

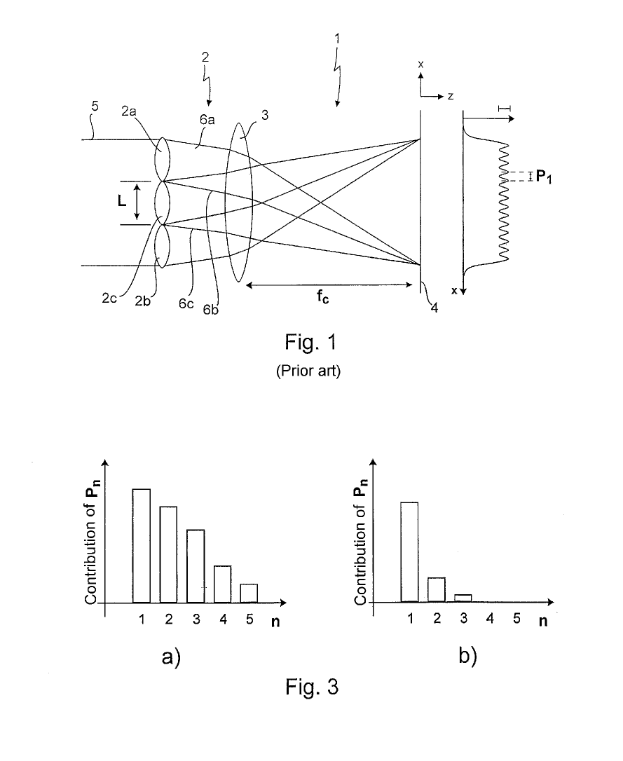

With regard to the mixing optical arrangement 18 it holds true, as has already been explained above with reference to FIG. 1, that when the light beam incident on the mixing optical arrangement 18 is divided into a plurality of partial rays in accordance with the light paths 24a-c in the substrate plane 14 in the X-dimension interference effects can occur, which lead to an interference contrast in the linear light beam in the substrate plane 14.

Various measures are described below for at least reducing, if not even eliminating, such interference phenomena or interference contrasts in the substrate plane 14.

The disclosure is based on the concept of providing at least one coherence-influencing optical arrangement in the beam path of the light beam, which acts on the light beam in such a way as to at least reduce the degree of coherence of the light for at least one light path distance of one light path from at least one other light path.

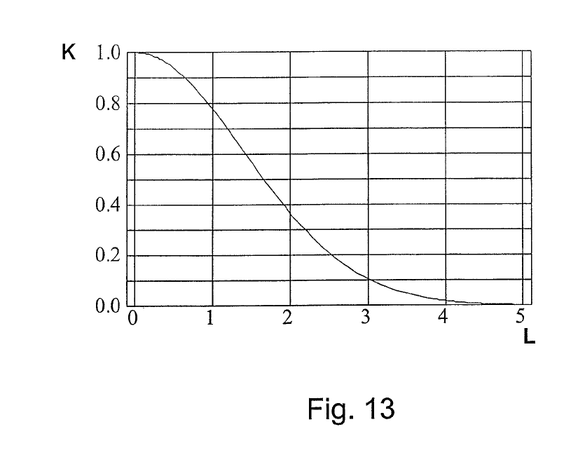

Before the various measures for reducing interference contrast are discussed in detail, the terms “lateral coherence length” and “coherence function” will be explained below. FIG. 13 illustrates the profile of a typical coherence function. The distance L is plotted in arbitrary units on the abscissa. By way of example, the light path distance between individual light paths from among the light paths 24a-c of the mixing optical arrangement 18 in FIG. 2 can be chosen as a unit. A distance of L=2 then means the distance of one light path from the next plus one light path to a side of the light path under consideration.

The degree of coherence, which can assume values of between 0 and 1 (0% and 100%), is indicated on the ordinate. The value 1 means complete coherence, and the value 0 means complete incoherence.

Without restricting the generality, the lateral coherence in the X-dimension is considered here, wherein the same holds true in the case where the mixing optical system 18 also performs mixing in the Y-dimension or a corresponding mixing optical arrangement is provided in addition to the arrangement 18.

The exemplary coherence function in accordance with FIG. 13 has an approximately Gaussian profile. All the explanations below can equally be applied to other coherence functions, in particular non-Gaussian coherence functions, coherence functions which do not fall monotonically, or else those coherence functions which already have minima or zeros.

Coherence length is understood to mean the distance L for which the degree of coherence K falls to a predetermined value. Without restricting the generality, in the present description the coherence length is considered to be the distance L for which the degree of coherence K has fallen to a value of 10% (0.1). In FIG. 13, this is the case for a distance L=3.

The measures to be described below are aimed at reducing the lateral coherence length. A first measure consists in setting the ratio of the lateral coherence length of the light beam and the light path distance (distance L) in such a way that the ratio is less than 2, preferably less than 1.

If the ratio of the lateral coherence length of the light beam in a direction transversely with respect to the light paths 24a-c and the light path distance L between two adjacent light paths is set to be less than 1, then interference phenomena can be almost completely avoided. This is because, in this case, adjacent light paths from among the light paths 24a-c cannot interfere with one another, or at most interfere with one another to a small extent.

FIG. 3a) illustrates the contribution made by the different interference periods Pₙ to the total interference contrast, as a function of the light paths n, for the case of a large coherence length, while FIG. 3b) illustrates the contribution of the various interference periods Pₙ for the case of a small coherence length. By reducing the lateral coherence length, it is thus possible for the proportion of the interferences to be largely reduced.

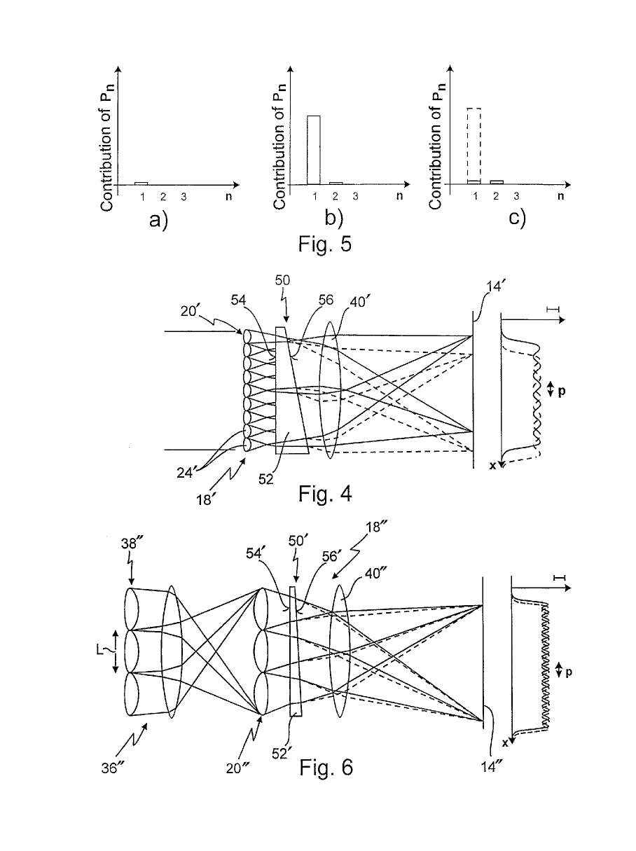

FIG. 4 illustrates a coherence-influencing optical arrangement 50. The optical arrangement 50 here has a birefringent optical element 52, whose light entrance surface 50 and light exit surface 56 are plane and inclined at an angle with respect to one another.

The birefringent optical element 52 splits the light beam incident in the light entrance surface 54 into an ordinary light ray and an extraordinary light ray, the ordinary light ray being illustrated here by solid lines and the extraordinary light ray being illustrated by interrupted lines. The angle between the light entrance surface 54 and the light exit surface 56 is then chosen in such a way that the phase difference—introduced by the optical element 52—between the ordinary and extraordinary partial rays for at least one light path distance is an odd-numbered multiple of half the wavelength of the light of the light beam. In this way, the interference fringes generated by the ordinary partial ray and the interference fringes generated by the extraordinary partial ray are offset relative to one another by half an interference period, such that the intensities of the light rays in the X-dimension in the substrate plane 14, on account of their incoherence with respect to one another, add up to a homogenous intensity distribution I.

In this case, it is preferred to choose the spatial orientation of the crystal of the birefringent element 52 in such a way that the intensities of the ordinary and extraordinary rays are as far as possible identical, in order that the interference patterns offset relative to one another precisely cancel one another out. This is fulfilled when the crystal axes in the XY plane are at an angle of 45° with respect to the light polarization plane.

FIG. 5a) shows a bar chart showing the proportions Pₙ of the different interference orders n for the case where the lateral coherence length is less than or equal to the light path distance between adjacent light paths 24′ of the mixing optical arrangement 18′. Interference phenomena are suppressed well by the choice of such a small lateral coherence length. FIG. 5b) shows the case where the lateral coherence length is only less than or equal to twice the light path distance between adjacent light paths. In this case, the contribution of the first interference order P₁ is still large, and only the contribution of P₂ and all further interference orders Pₙ where n>2 are suppressed. FIG. 5c) then shows the case where the lateral coherence length is less than or equal to twice the light path distance between adjacent light paths, the birefringent optical element 52 additionally being present in the beam path. The contribution of P₁ in accordance with FIG. 5b) is illustrated by interrupted lines in FIG. 5c), and the contribution of P₁ when using the birefringent optical element 52 is shown by solid lines.

It is evident from FIG. 5c) that, by using at least one birefringent optical element 52 having non-plane-parallel light entrance and light exit surfaces, an interference order (and its odd multiples), in particular the first (P₁), can be suppressed in a targeted manner. This enables the lateral coherence length in relation to the light path distance or conversely the number of light paths to be chosen to be greater in comparison with the case without such birefringent optical elements.

FIG. 6 illustrates an exemplary embodiment which is modified compared with FIG. 4 and in which a coherence-influencing optical arrangement 50′ has a birefringent optical element 52′ having a non-plane-parallel light entrance surface 54′ and light exit surface 56′. In contrast to the exemplary embodiment in accordance with FIG. 4, two mixing optical arrangements 18″ and 36″ similar to FIG. 2 are present.

The use of a plurality of mixing optical arrangements has the advantage that the light path distance L particularly in the case of the second mixing optical element 20″ in the propagation direction of the light beam can be chosen to be greater, as a result of which the interference periods in the substrate plane 14″ correspondingly become smaller and the angle between the light entrance surface 54′ and the light exit surface 56′ of the birefringent optical element 52′ can likewise be chosen to be smaller. Despite a larger light path distance L, a higher mixing effect is achieved by the multistage mixing, and the interference patterns of the ordinary and extraordinary partial rays are offset relative to one another to a lesser extent in the substrate plane 14″, and, in addition, chromatic aberrations are reduced and the desired properties of the adjustment accuracies of the optical system are reduced.

While the birefringent optical element 52 in FIG. 4 and the birefringent optical element 52′ in FIG. 6 are respectively arranged between the cylindrical lens array 20′ and 22″ and a downstream condenser optical unit 40′ and 40″, respectively, the birefringent optical elements can also be arranged at other locations in the beam path of the light beam, for example also upstream of the respective mixing optical arrangement 18′ and 18″ or else completely downstream thereof, that is to say downstream of the condenser optical units 40′ and 40″.

Furthermore, two or more of such birefringent optical elements 52 or 52′ can be used in the optical system 10 in FIG. 2 if this is advantageous for the reduction of interference contrasts in the substrate plane 14.

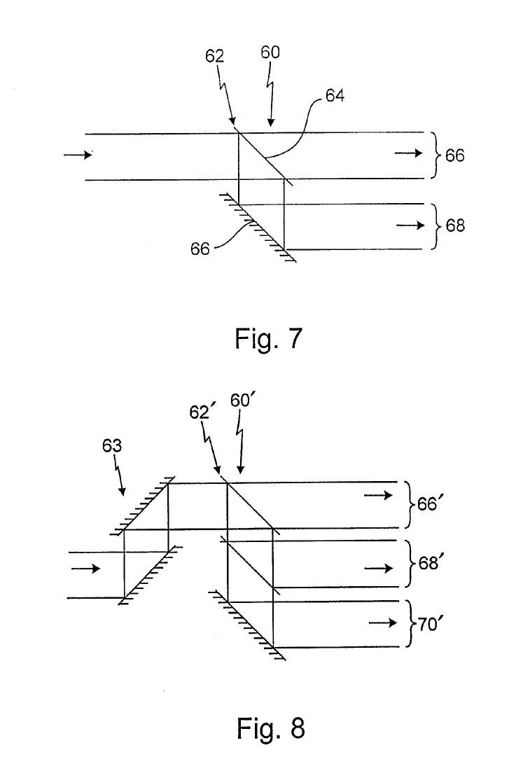

A further measure for reducing interference contrasts in the substrate plane 14, which are provided as an alternative or in addition to the measures described above in the optical system 10 in FIG. 2, is illustrated in FIGS. 7 and 8.

FIG. 7 shows a coherence-influencing optical arrangement 60 having a beam splitter arrangement 62. The beam splitter arrangement 62, which has a partly transmissive mirror 64, for example, splits the light beam in a direction transversely with respect to the light paths 24 and 26 (that is to say in the X-dimension) into a plurality of laterally offset parallel partial rays 66, 68, wherein the propagation path difference of the partial rays 66 and 68 relative to one another is greater than the temporal coherence length of the light of the partial rays 66, 68. In the exemplary embodiment in accordance with FIG. 7, the beam splitter arrangement 62 splits the light beam into two partial rays 66, 68. The partial ray 68 arises as a result of reflection of the incident light beam at the partly transmissive mirror 64 and reflection at a fully reflective mirror 66. The partial rays 66 and 68 are placed laterally beside one another by the optical arrangement 60 in the X-dimension. The splitting of the incident light beam into a plurality of partial rays 66, 68 placed laterally alongside one another has the effect that the ratio of the lateral coherence length to the beam diameter of the entire beam is reduced, and the ratio of lateral coherence length and light path distance is likewise reduced, for the same total number of light paths.

FIG. 8 shows a coherence-influencing optical arrangement 60′ which is modified by comparison with FIG. 7 and in which the incident light beam is split into three partial rays 66′, 68′ and 70′, as a result of which the lateral coherence length in relation to the light path distances between the light paths 24 can be reduced even further.

Under certain circumstances, it is advantageous to correct a lateral beam offset introduced by the optical arrangement 60 or 60′, as is illustrated by an arrangement 63 in FIG. 8.

The optical arrangements 60 and 60′ can be arranged upstream of the light entrance plane 12, for example, in the optical system 10.

Instead of partly transmissive mirrors, such beam splitter arrangements can also use plates, prisms (using total internal reflection) and/or beam splitter layers.

In particular, the optical arrangement 60 or 60′ can also be embodied as a plane-parallel plate which is inclined relative to the beam and through which the partial beam 66 passes, while the partial beam 68 is reflected twice within the plate. Further partial rays can be generated by multiple reflection. In this case, it is advantageous if the different regions of the plate have coatings having a different, respectively adapted reflectivity, such that the partial rays have the same intensity.

A further measure for reducing the lateral coherence length consists in arranging a coherence-influencing optical arrangement (not illustrated) in the beam path of the light beam, which arrangement has a coherence converter arrangement in accordance with DE 10 2006 018 504 A1. Such a coherence converter arrangement likewise has a beam splitter arrangement that splits the incident light beam in the X-dimension into a plurality of partial rays, and additionally a beam resorting arrangement, which then arranges the partial rays beside one another in the direction of the other dimension. Afterward, compression of the light beam in the latter dimension and expansion in the former dimension take place. For a more detailed description of such a coherence converter arrangement, reference is made to the abovementioned document, the disclosure of which is incorporated by reference in the present disclosure.

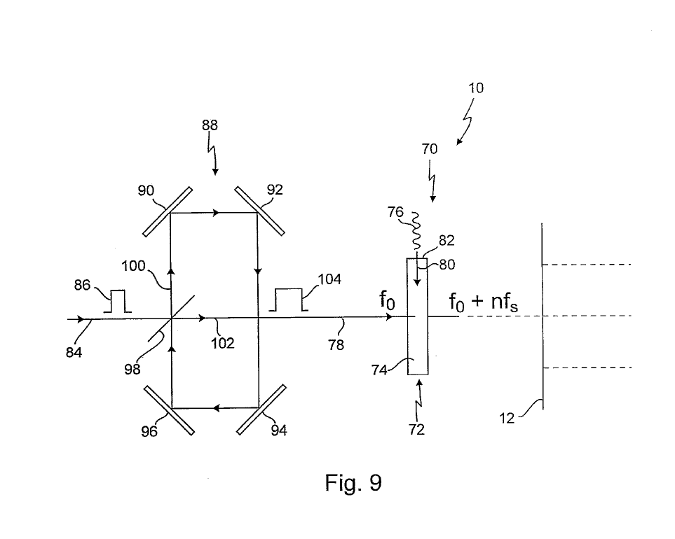

Referring to FIG. 9, a description will be given of further measures for reducing interference contrasts in the substrate plane 14 of the optical system 10 in FIG. 2. The measures described below can be used as an alternative or in addition to the measures already described above.

FIG. 9 illustrates a coherence-influencing optical arrangement 70 having an acousto-optical modulator (AOM) 72. The AOM 72 has an optical element 74, e.g. a plate, in which a sound wave 76 is generated, which propagates transversely with respect to the incident light beam 78 in the optical element 74, as is illustrated by an arrow 80. The sound wave 76 can be generated e.g. by a piezoactuator (not illustrated) arranged at one end 82. The sound wave 76 propagating through the optical element 74 has the effect that the optical element 74 acts as a diffraction or phase grating for the incident light beam 78. The sound wave 76 can have e.g. an acoustic frequency fₛ in the ultrasound range of approximately 5 MHz to 1 GHz.

When the sound wave 76 passes through the optical element 74, it brings about a periodic density modulation and hence a periodic refractive index modulation in the optical element 74, which produces the effect of the abovementioned diffraction or phase grating. The light passing through the AOM 72 thereby experiences a phase shift 6 which is dependent on position and time and which has, specified in fractions of the optical wavelength, the following form:

*(x,t)=a sin [2π(x/7−fₛt)] (2)

In this case, a is dependent on the sound amplitude and the extent of the sound field in the direction of the optical axis. 7 designates the wavelength of the sound wave, and fₛ designates the frequency of the sound wave.

The time-dependent phase shift results in a decorrelation of the light from different locations, as a result of which the lateral coherence is reduced. The reduction of the degree of coherence and hence the reduction of the interference contrast for a light path distance L is dependent on the amplitude a and the wavelength 7 of the AOM 72 and on the light path distance L.

The AOM 72 is then designed in interaction with the mixing optical arrangement 18 in FIG. 2, which divides the light beam incident on the mixing optical arrangement 18 into a plurality of partial fields 28a, 28b, 28c, which are superimposed on one another in the substrate plane 14, with respect to the light paths 24 and 26 in such a way that the lateral coherence for the distance between the light paths is reduced and interferences are correspondingly reduced.

In particular, the acoustic wavelength A and the acoustic amplitude a of the AOM 72 can be set or are set in such a way as to meet the condition

J₀[|2a sin(πL/Λ)|]<<1 (³)

for at least one light path distance L, where J₀ is the 0-th order Bessel function.

With the definition x₀=|2a sin(πnL/Λ)|, the zeros of the Bessel function J₀ are at x₀=2.40483, 5.52008, 8.65373, 11.7915, . . .

If L=Λ does not exactly hold true, then the condition (3) can always be met through a suitable choice of the amplitude a of the sound wave 76. On account of the sine periodicity, the condition likewise applies to values L+mΛ, and on account of the symmetry it also applies to (7−Λ)+mΛ. Particular preference is given to the cases in which the condition (3) is furthermore met for further light path distances L or the integral has at least a value<<1:

| a | L/Λ | J₀[\|2a sin (πL/Λ\|)] |
|---|---|---|
| $\frac{{x}_{0}}{2}$ | $\frac{1}{2} + m$ | 0 |
| $\frac{{x}_{0}}{\sqrt{3}}$ | $\frac{1}{3} + m$ | 0 |
| $\frac{{x}_{0}}{\sqrt{3}}$ | $\frac{2}{3} + m$ | 0 |
| 1.92 x₀ | $\frac{1}{5} + m$ | 0.033 |
| 1.92 x₀ | $\frac{2}{5} + m$ | 0.033 |
| 1.92 x₀ | $\frac{3}{4} + m$ | 0.033 |
| 1.92 x₀ | $\frac{4}{5} + m$ | 0.033 |

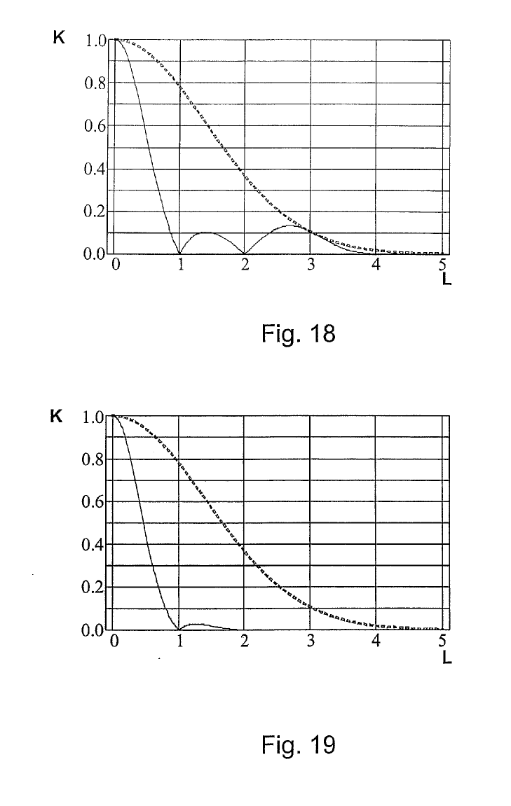

Special cases of the condition (3) will also be described later with reference to FIGS. 17 and 18.

Relatively prime multiples of the ratio L/Λ and corresponding greater frequencies fₛ of the AOM 72 and corresponding greater amplitudes associated with further zeros x₀ of the Bessel function J₀ are also possible with the same effect. However, the design of the AOM 72 is not restricted to these cases; rather, there are a multiplicity of combinations of frequencies fₛ and amplitudes a of the AOM 72 which significantly reduce one or more interference orders in the substrate plane 14.

In order to find an optimum here, the acoustic wavelength Λ and/or the acoustic amplitude a of the AOM 72 are/is adjustable in order to meet the abovementioned condition (3) as well as possible.

In particular, however, the entire range is useful in which the condition

a sin (πL/Λ)>0.75 (4)

is met for a specific or typical light path distance L.

If the condition mentioned above is met, the Bessel function J₀ is <0.5.

Referring to FIG. 9 again, a further aspect of the optical system 10 will now be described for the case where the light beam 84 generated by a light source (not illustrated), for example a laser, is pulsed, i.e. consists of a sequence of individual light pulses. FIG. 9 schematically illustrates such a light pulse 86.

As already explained above, on account of the dynamic phase differences the AOM 72 brings about a decorrelation of the light at different locations. This decorrelation is complete only when averaging can be effected over as many sound periods as possible having a uniform intensity, as is the case in particular for a laser in continuous wave operation. For a short-pulse laser, by contrast, such as an excimer laser, in which the pulse duration of, for example, 20 ns is in the range of typical AOM frequencies of, for example, 20-100 MHz (period duration 10-50 ns), this condition is not met and a residual interference contrast thus arises in the substrate plane 14.

In order to avoid such interference contrasts in the substrate plane 14, therefore, the AOM 72 in accordance with FIG. 9 is combined with a pulse lengthening module 88. The pulse lengthening module 88 is illustrated schematically here and merely by way of example as an arrangement of four mirrors 90, 92, 94, 96. Any other design of the pulse lengthening module 88, in particular those such as are known per se, can be used here. The pulse lengthening module 88 has, on the input side, a beam splitter 98, for example a semitransparent mirror, which splits the incident light beam 84 into a first (reflected) partial ray 100 and a (transmitted) second partial ray 102. While the partial ray 102 passes through the pulse lengthening module 88 on a short path, the partial ray 100 passes through the delay section formed by the mirrors 90, 92, 94, 96 and is coupled out, after once again impinging on the beam splitter 98, from the pulse delay module 88 with the other partial ray 102. Through corresponding dimensioning of the delay section defined by the mirrors 90, 92, 94, 96, the light pulse which has passed through the delay section attaches directly to a light pulse that has not passed through the delay section, thus giving rise to a light pulse 104 having approximately double the length of the light pulse 86.

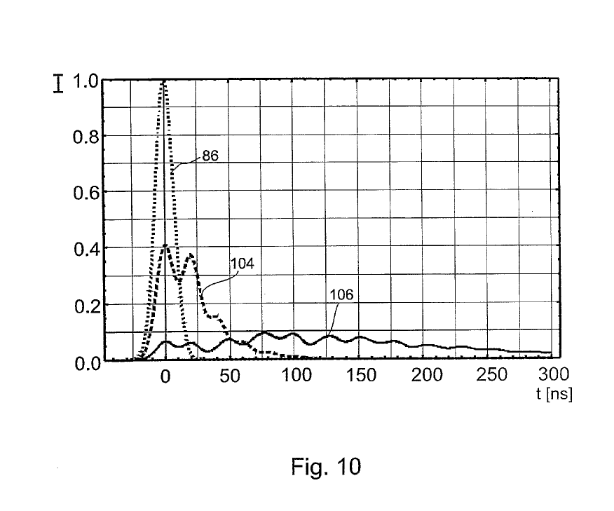

In FIG. 10, the intensity I of the light pulse 104 is plotted against the time t. The intensity of the pulse 104 subsides more slowly by comparison with the light pulse 86. Moreover, the intensity of the light pulse 104 has a modulation with a characteristic time scale which corresponds to the circulation duration of the pulse 100 in the pulse lengthening module 88.

It goes without saying that a plurality of pulse lengthening modules disposed in series can be provided instead of only one pulse lengthening module 88. FIG. 10 illustrates the intensity of a light pulse 106 shaped from the original light pulse 86 after passing through three pulse lengthening modules arranged one after another. Here, too, a modulation is manifested in the envelope of the intensity.

The combination of the at least one pulse lengthening module 88 and the AOM 72 is then advantageously used to reduce the contrast caused by interferences in the substrate plane 14. For this purpose, the acoustic frequency fₛ or its integral multiple n·fₛ is coordinated with the lengthened pulses in such a way that the image contrast caused by interferences in the image plane is less than 10%, preferably less than 5%, with further preference less than 1%.

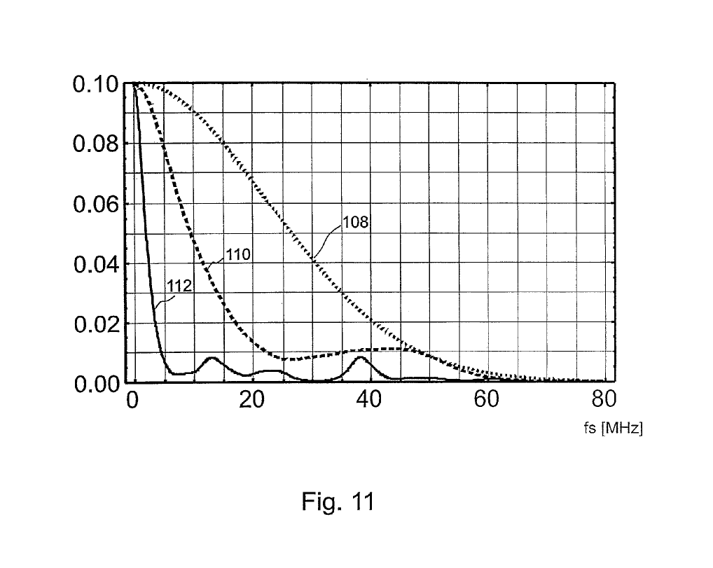

In order to illustrate the effect of pulse lengthening on the interference contrast in the substrate plane 14, FIG. 11 shows a diagram in which there is plotted on the abscissa the acoustic frequency fₛ and on the ordinate the residual interference contrast when use is made of an AOM for the three pulse shapes 86, 104, 106 in FIG. 10.

In FIG. 11, a curve 108 represents the profile of the interference contrast in the substrate plane 14 for the pulse shape of the pulse 86 in FIG. 10, that is to say for the original (short) light pulse 86, as a function of the acoustic frequency fₛ. The higher the acoustic frequency fₛ, the smaller the ratio of acoustic period duration and pulse duration of the laser light becomes, and the smaller the residual interference contrast is, since averaging can be effected over a larger number of sound periods. The curve 110 shows the dependence of the interference contrast on the acoustic frequency fₛ for the pulse 104 (passage of the light beam through a pulse lengthening module 88), and the curve 112 shows the dependence of the interference contrast on the acoustic frequency fₛ for the pulse 106 in FIG. 10, which corresponds to the passage of the light beam through three pulse lengthening modules arranged one after another.

As emerges from FIG. 11, via the lengthening of the pulse duration of the light pulses via a corresponding number of pulse lengthening modules, the interference contrast in the substrate plane 14 is substantially reduced over a large range of acoustic frequencies fₛ. Consequently, a lengthening of the pulse durations of the pulsed light beam already brings about a reduction of the interference contrasts and thus an improvement in the homogeneity of the light beam in the substrate plane 14.

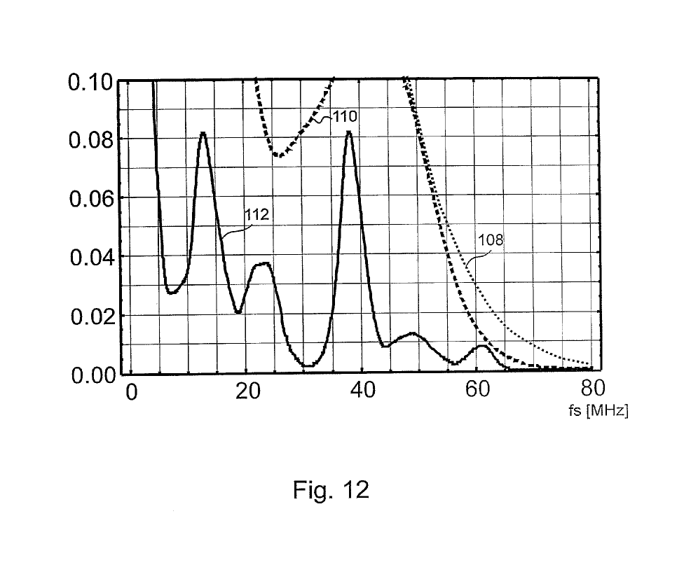

As shown in FIG. 12, which is a fine representation of the diagram in FIG. 11 with respect to the stretching of the ordinate, in the case of the triply lengthened light pulse in accordance with the curve 112 as well there are, however, frequency ranges in which the interference contrast is still significantly higher than in the remaining acoustic frequency ranges fₛ. In the present case, such an increased interference contrast is situated e.g. in the range of fₛ≈40 MHz. The frequency ranges fₛ in which the interference contrast is still increased correspond to the circulation frequencies (reciprocals of the circulation durations) in the respective pulse lengthening modules. In addition, further maxima occur at the multiples of these circulation frequencies.

The acoustic frequency fₛ therefore has to be chosen such that the frequency ranges with minimal interference contrast are found. The acoustic frequency fₛ of the sound wave 76 is to be correspondingly set at the AOM 72.

In particular, the acoustic frequency fₛ has to be chosen such that it is different from the circulation frequencies of the pulse delay modules and the integral multiples thereof, as is evident from FIG. 12.

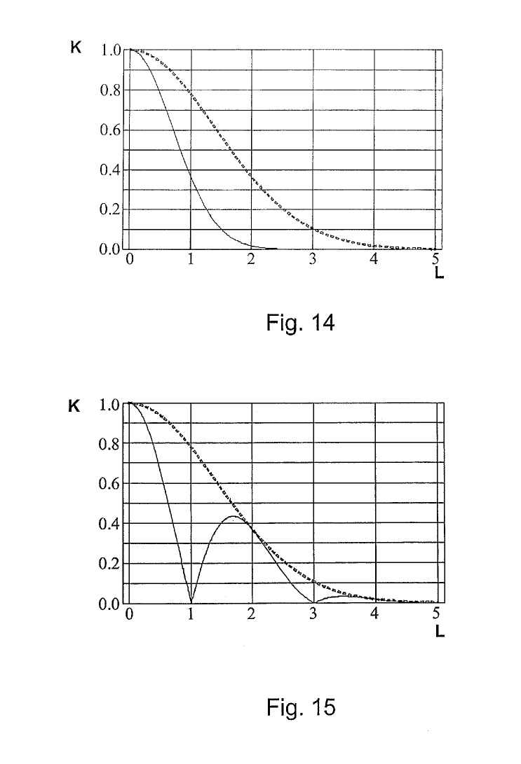

Referring to FIGS. 14 to 21, on the basis of the exemplary coherence function in FIG. 13, a description is given of the influence of the various measures described above on the lateral coherence length of the light relative to the distance between the light paths 24 and 26.

FIG. 14 shows the profile of the coherence function (with a solid line) in the case of the measure where a beam splitter arrangement is present in the beam path, as is illustrated by way of example in FIG. 7. The beam splitting into two partial rays (partial rays 66, 68 in FIG. 7) brings about a reduction of the coherence length for the same beam cross section by a factor of 2, as is evident from FIG. 14. The 10% value of the degree of coherence K is accordingly already attained at a distance L of 1.5.

FIG. 15 shows the effect of birefringent elements on the coherence function. Here use was made of at least one birefringent wedge-shaped element whose angle between light entrance surface and light exit surface was chosen such that the degree of coherence between two adjacent light paths, that is to say the coherence function for L=1, is zero. As is evident from FIG. 15, further zeros of the coherence function arise at L=3, L=5.

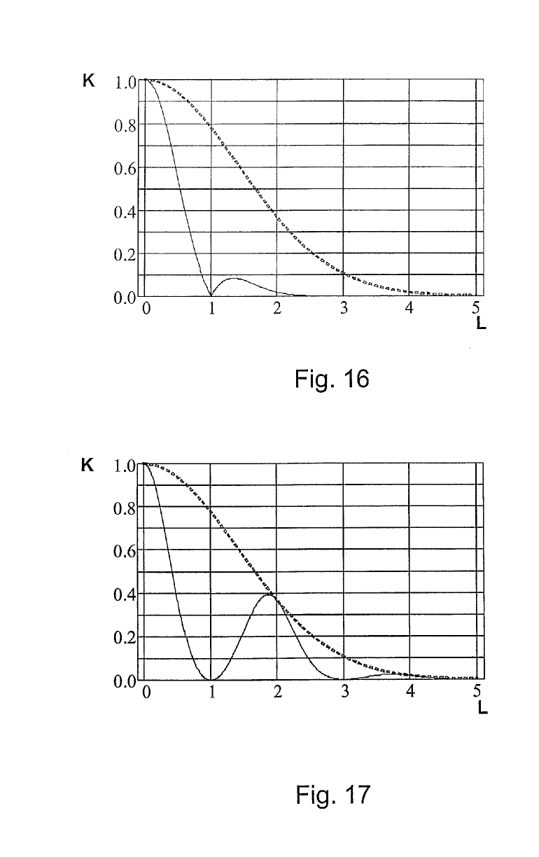

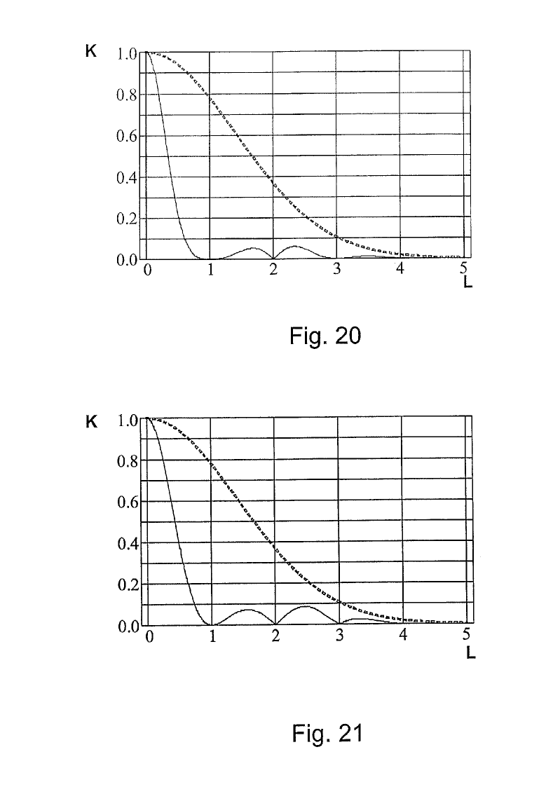

FIG. 16 shows the effect of a combination of birefringent wedge-shaped elements whose effect are adapted to the distance L=1, and of beam splitting into two partial rays (c.f. FIG. 7), on the coherence function. If the light path distance between adjacent light paths L=1, then it is evident from FIG. 20 that interferences between the individual light paths are virtually completely suppressed. Even the coherence of light of one light path with light of a directly adjacent light path is reduced to less than 10%.

FIG. 17 shows the effect of the acousto-optical modulator 72 having an amplitude a of the sound wave 76 of a=1.20241 and a sound wavelength 7 of 7=2 (in the units of the abscissa in FIG. 17).

Zeros of the coherence function arise at half the sound wavelength 7 (L=1) and odd multiples thereof (L=3, 5).

FIG. 18 shows the effect of the acousto-optical modulator 72 having an amplitude of the sound wave 76 of a=1.38843 and a sound wavelength 7=3.

In this case, zeros of the coherence function arise at multiples of 7/3, i.e. at L=1, L=2, L=4.

FIG. 19 shows the effect of the acousto-optical modulator with the same parameters as in FIG. 18, but in combination with a beam splitter arrangement that splits the incident light beam into two partial rays in accordance with FIG. 7.

In this case, interference effects between adjacent light paths of the mixing optical arrangement are almost completely eliminated by this combination of interference-suppressing measures.

FIG. 20 shows the coherence function for the case where the acousto-optical modulator 72 is operated with two different sound wavelengths 7 or two different sound frequencies fₛ, wherein the sound wavelengths 7 from the examples in FIGS. 17 and 18 were used.

This effect corresponds to disposing in series two acousto-optical modulators having the parameters in accordance with FIGS. 17 and 18. Instead of using two or more acousto-optical modulators that are operated with different frequencies and/or sound amplitudes, it is also possible to use a single acousto-optical modulator, which is excited with different frequencies and amplitudes.

In accordance with FIG. 20, zeros of the coherence function arise at L=1, 2, 3, 4, 5, and in the range between the zeros the degree of coherence K is likewise reduced to less than 10%.

FIG. 21 shows the coherence function for the case of using the acousto-optical modulator having the parameters in accordance with FIG. 18 in combination with birefringent elements whose effect on the coherence function corresponds to that from FIG. 15.

In this case, a zero arises at L=1, which originates from the acousto-optical modulator and from the birefringent elements. For the case where the interference-reducing effect of the AOM 72 or of the birefringent elements 52 and 52′ is in each case not optimal by itself, these two measures thus advantageously complement one another at L=1 in order to force the degree of coherence to zero.

Further zeros of the coherence function in FIG. 21 exist at L=2, which originates from the AOM, at L=3, which originates from the birefringent elements, and at L=4, which originates from the AOM, etc.

The coherence functions in accordance with FIGS. 14 to 21 should be understood merely by way of example. Coherence functions other than that in FIG. 13 are conceivable, which are therefore non-Gaussian. Depending on the desired properties, the above-described measures for reducing interference can also be designed such that they have correspondingly different effects on the coherence function; by way of example, in contrast to the examples shown in FIGS. 14 to 21, the zeros of the coherence function can also be distributed non-equidistantly.

What is claimed is:

1. An optical system configured to generate a light beam having a propagation direction, a beam length in a first dimension perpendicular to the propagation direction, and a beam width in a second dimension perpendicular to the first dimension and perpendicular to the propagation direction, the optical system comprising:
a first optical arrangement configured to divide the light beam in at least one of the first and second dimensions into a plurality of light paths that are superimposed on one another in the substrate plane; and
a second optical arrangement configured to at least reduce a degree of coherence of the light for at least one light path distance of one light path from at least one other light path,
wherein the second optical arrangement comprises an acousto-optical modulator, Λ is an acoustic wavelength of the acousto-optical modulator, a is an acoustic amplitude of the acousto-optical modulator, and J₀[|2a sin(πL/Λ)|]<<1 for the at least one light path distance, where J₀ is the 0-th order Bessel function.

2. The optical system of claim 1, wherein a ratio of a lateral coherence length of the light beam in a direction transverse to the plurality of light paths and the light path distance between at least two adjacent light paths is less than 2.

3. The optical system of claim 1, wherein a ratio of a lateral coherence length of the light beam in a direction transverse to the plurality of light paths and the light path distance between at least two adjacent light paths is less than 1.

4. The optical system of claim 1, wherein the second optical arrangement comprises a beam splitter arrangement configured to slit the light beam in a direction transverse to the plurality of light paths into a plurality of laterally offset partial rays whose propagation path differences relative to one another are greater than a temporal coherence length of the light of the laterally offset partial rays.

5. The optical system of claim 1, wherein the second optical arrangement comprises a coherence converter arrangement comprising a beam splitter and a beam resorting arrangement, the coherence converter arrangement being configured to split the light beam into a plurality of partial rays in a direction of one of the first and second dimensions, and the beam resorting arrangement being configured to arrange the plurality of partial rays alongside each other in a direction of the other of the first and second dimensions.

6. The optical system of claim 1, wherein the second optical arrangement comprises a birefringent optical element having a light entrance surface and a light exit surface, the light entrance surface and the light exit surface being plane and inclined at an angle with respect to one another.

7. The optical system of claim 6, wherein the light entrance surface and the light exit surface are chosen so that, during use of the system, the optical element introduces a phase difference between ordinary and extraordinary partial rays for the at least one light path distance that is an odd numbered multiple of half the light wavelength.

8. The optical system of claim 6, wherein the birefringent optical element is the propagation direction of the light beam downstream of the first optical arrangements.

9. The optical system of claim 1, comprising a plurality of optical arrangements configured to divide the light beam in at least one of the first and second dimensions into a plurality of light paths that are superimposed on one another in the substrate plane.

10. The optical system of claim 1, wherein characterized in at least one parameter of the acousto-optical modulator is adjustable, the at least parameter being selected from the group consisting of the acoustic wavelength and the acoustic amplitude.

11. The optical system of claim 1, wherein L is the at least one light path distance, and sin (πL/7)<0.75.

12. The optical system of claim 1, wherein the second optical arrangement comprises a plurality of acousto-optical modulators, an acoustic wavelength and/or the acoustic amplitude are/is being different from acousto-optical modulator to acousto-optical modulator to reduce the degree of coherence for a plurality of light path distances.

13. The optical system of claim 1, wherein the second optical arrangement includes only one acousto-optical modulator, and the acousto-optical modulator has a plurality of different acoustic wavelengths and/or acoustic amplitudes to at least reduce the degree of coherence for a plurality of light path distances.

14. The optical system of claim 1, wherein the light beam is a pulsed light beam, and the optical system further comprises a pulse lengthening module in the beam path.

15. The optical system of claim 14, wherein the acoustic wavelength of the acousto-optical modulator or the integral multiples thereof is/are coordinated with the lengthened pulses so that an interference contrast in the substrate plane is less than 10%.

16. The optical system of claim 14, wherein the acoustic wavelength of the acousto-optical modulator or the integral multiples thereof is/are coordinated with the lengthened pulses so that an interference contrast in the substrate plane is less than 5%.

17. The optical system of claim 14, wherein the acoustic wavelength of the acousto-optical modulator or the integral multiples thereof is/are coordinated with the lengthened pulses so that an interference contrast in the substrate plane is less than 1.

18. The optical system of claim 14, wherein a sound frequency of the acousto-optical modulator is different from a circulation frequency of the pulses in the pulse lengthening module, and sound frequency of the acousto-optical modulator is different from to an integral multiple of the circulation frequency.

19. The optical system of claim 18, wherein the sound frequency of the acousto-optical modulator differs from the circulation frequency of the pulses and all integral multiples in the pulse lengthening module by more than 5%.

20. The optical system of claim 18, wherein the sound frequency of the acousto-optical modulator differs from the circulation frequency of the pulses and all integral multiples in the pulse lengthening module by more than 10%.
